(19) United States
(12) Patent Application Publication
(10) Pub. No.: US 2013/0159196 A1
(43) Pub. Date: Jun. 20, 2013

(54) Secure PIN Verification for Mobile Payment Systems

(71) Applicant: Jim Michael DiZoglio, Mountain View, CA (US)

(72) Inventor: Jim Michael DiZoglio, Mountain View, CA (US)

(73) Assignee: eBay, Inc., San Jose, CA (US)

(21) Appl. No.: 13/331,088

(22) Filed: Dec. 20, 2011

(51) Int. Cl. G06Q 20/20; G06Q 20/32; G06Q 20/40

(52) U.S. Cl. 705/72

(57) ABSTRACT

Methods and systems are provided for secure electronic payment for merchandise at a point of sale. The secure verification of a personal identification number (PIN) via a mobile payment system is facilitated. A memory stores account information for a plurality of users, the account information includes a personal identification number (PIN) for at least some of the users. A processor receives a communication including an indication of a desire of a user to purchase an item from a merchant. The processor accesses an account of the user and provides a random keypad to the merchant. The user uses the random keypad to enter the PIN. The processor receives touch screen information from a mobile device of the user and makes a reconstructed PIN from the random keypad and the touch screen information. The processor authorizes the purchase if the reconstructed PIN is the PIN of the user.

### BACKGROUND

1. Technical Field

The present disclosure generally relates to electronic payment for merchandise at a point of sale and, more particularly, to facilitating secure verification of a personal identification number (PIN) via a mobile payment system.

2. Related Art

The use of a personal identification number (PIN) to facilitate a purchase at a point of sale is well known. A common example involves the use of a bank debit card. The debit card is swiped and the customer or user enters the PIN into a merchant terminal at the point of sale during checkout. In this instance, the merchant terminal captures and stores the PIN, at least momentarily. The PIN helps to identify the user and thus provides assurance that the transaction is authorized.

Mobile payment systems can to be used to make purchases at a point of sale. In a mobile payment system, a user uses a cellular telephone or other mobile device to facilitate payment. For example, the user may use an application that requires entry of the user's PIN via a keypad of the mobile device to facilitate authorization for the transaction from a payment provider. In this instance, the mobile device captures and stores the PIN, at least momentarily.

Whether the user uses a merchant terminal or uses a mobile device during checkout, entering the PIN needs to be done securely. It is important that entry of the PIN not be observed visually or intercepted electronically. Any time that the PIN is captured and stored, it is susceptible to being observed or intercepted. If the PIN is observed visually or intercepted electronically, then the PIN has been compromised and unauthorized transactions can subsequently occur.

When the PIN is entered in the contemporary manner via the keypad of a merchant terminal or via the keypad of a mobile device, such entry is susceptible to being observed visually. That is, a bystander can watch the user enter the PIN. Further, when the PIN is entered in the contemporary manner via the keypad of a merchant terminal or via the keypad of a mobile device, the PIN can be intercepted electronically.

### SUMMARY

According to one or more embodiments, a consumer or user has an account with a payment provider, such as PayPal, Inc. When the user is ready to make a purchase, such as at a point of sale, the user is required to provide a personal identification number (PIN). The PIN can be verified securely using augmented reality. The PIN cannot readily be observed or intercepted and then used illegitimately at a later time. A mobile device is used to provide information related to the PIN without entering the PIN itself. The information entered can change for each transaction. Since the information is not the PIN, it cannot be used illegitimately by someone who observes or intercepts the information.

According to one or more embodiments, methods and systems are provided for facilitating the authorization of a user/merchant transaction via a PIN without the user entering the PIN into any device. Instead of entering the PIN, the user can use a touch screen of a mobile device that displays augmented reality to provide screen tap information or drag-and-drop information which can be used by a payment server or the like to reconstruct the PIN.

According to one or more embodiments, a payment providing system has a memory for storing account information for a plurality of users. The account information can include a personal identification number (PIN) for at least some of the users. A processor can be operable to receive a communication including an indication of a desire of a user to purchase an item from a merchant. The processor can access an account of the user and can provide a random keypad to the merchant or the user. The user can use the random keypad to enter the PIN. Augmented reality can facilitate use of the random keypad. The processor can receive touch screen information from a mobile device of the user and can make a reconstructed PIN from the random keypad and the touch screen information. The processor can authorize the purchase if the reconstructed PIN is the PIN of the user.

The communication can comprise a merchant ID and a first token that is representative of a shopping cart of the user. The random keypad can be provided to the merchant via a second token. The random keypad can be provided to the merchant by providing a random number to the merchant such that the random keypad is derivable from the random number. For example, the random keypad can be provided to the merchant by providing a non-repeating random sequence of ten digits to the merchant.

The touch screen information can be information that is representative of which keys on a random keypad were tapped. The touch screen information can be information that is representative of which keys on a random keypad were dragged and dropped and to where the keys were dragged.

### BRIEF DESCRIPTION OF THE DRAWINGS

FIG. 1 is a block diagram showing a secure PIN verification system, in accordance with one or more embodiments;

FIG. 2 shows a merchant display having a random keypad for use in a particular checkout, in accordance with one or more embodiments;

FIG. 3 shows a mobile device touch screen when viewing the merchant display of FIG. 2, in accordance with one or more embodiments;

FIG. 4 shows the mobile device touch screen of FIG. 3 when a user is entering the PIN by tapping a random keypad, in accordance with one or more embodiments;

FIG. 5 is a flow chart showing examples of steps for secure PIN verification for mobile payment systems, in accordance with one or more embodiments;

FIG. 6 shows a merchant display having a random keypad and slots for use in a particular checkout, in accordance with one or more embodiments;

FIG. 7 shows a mobile device touch screen when viewing the merchant display of FIG. 6, in accordance with one or more embodiments;

FIG. 8 shows the mobile device touch screen of FIG. 7 when a user is entering the PIN by dragging and dropping numbers of a random keypad, in accordance with one or more embodiments; and

FIG. 9 is a flow chart showing examples of steps for secure PIN verification for mobile payment systems, in accordance with one or more embodiments.

### DETAILED DESCRIPTION

According to one or more embodiments, methods and systems are provided for using augmented reality to facilitate the authorization of a user/merchant checkout transaction at a point of sale. Customer or user events in the augmented reality are captured to identify the user requesting the checkout transaction. The transaction requires the verification of a personal identification number (PIN). However, the PIN is not entered into any device at the point of sale. Rather, the user events are used by a payment server to reconstruct the PIN. Thus, the PIN cannot readily be intercepted at the point of sale.

More particularly, according to one or more embodiments the user can enter information other than the PIN into a mobile device and this information can be used to reconstruct the PIN. However, the information entered by the user can only be used to reconstruct the PIN when the information is combined with additional information. That is, both the information entered by the user and the additional information are needed to reconstruct the PIN.

A merchant display can be viewed by the mobile device to provide an imaged that is enhanced with augmented reality. The augmented reality image of the merchant display can provide graphics that can be manipulated by the user to facilitate the entry of information by the user using the mobile device. Thus, the merchant display can cooperate with the mobile device to define an interactive digital window.

The additional information can originate from a payment server. Thus, when the payment server is provided with the information entered by the user, the payment server has both the information entered by the user and the additional information and therefore the payment server can reconstruct the PIN and authorize payment.

The information entered by the user can be referred to herein as a pseudo PIN. The pseudo PIN can be entered at the point of sale and the pseudo. PIN can be communicated to the payment server where the pseudo PIN is combined with the additional information to reconstruct the PIN. In this manner, the PIN can, in effect, be forwarded from the point of sale to the payment server without actually ever being entered, captured, stored, or transmitted at the point of sale. Thus, the likelihood of compromising the PIN can be substantially mitigated.

The PIN cannot be reconstructed from the pseudo PIN alone. Rather, the pseudo PIN must be combined with the additional information to reconstruct the PIN. The reconstruction of the PIN can be performed at a secure location, where the PIN is not subject to interception. The secure location can be remote with respect to the point of sale. For example, the secure location can be at or associated with the payment server.

In one or more embodiments, the pseudo PIN can be information regarding the use of a touch screen by the user. For example, the pseudo PIN can be information regarding where the user has touched or tapped the touch screen of the mobile device. As another example, the pseudo PIN can be information regarding drag-and-drop operations performed by the user on the touch screen. Thus, the screen tap information or the drag-and-drop information can be combined with the additional information to reconstruct the PIN.

According to one or more embodiments, the additional information can be the locations of the numbers of a random keypad that is displayed, using augmented reality, on the mobile device. The random keypad can have the numbers thereof scrambled, such that the numbers are not in the same sequence or locations where the numbers are on a standard keypad. A different random keypad can be provided for each checkout. In this instance, the pseudo PIN can be screen tap information that is indicative of where the user tapped the touch screen of the mobile device. The user can tap the numbers that correspond to the user's PIN, but rather than communicating the user's PIN to the payment server, the mobile device communicates the locations on the touch screen which were tapped.

One observing the user enter the PIN would typically see only the tapped locations and not the numbers themselves. One electronically intercepting communications from the mobile device would only intercept the pseudo PIN, i.e., the information that is indicative of where the user tapped the touch screen. Without knowing what numbers on the random keypad these locations correspond to, anyone intercepting the locations cannot determine the PIN. The payment server knows what numbers the locations correspond to because the payment server defined the locations.

According to one or more embodiments, the additional information can be the locations of the numbers of a random keypad and the locations of a number of input tracks or slots into which the numbers can be dragged and dropped, all of which are displayed, using augmented reality, on the mobile device. The number of slots can correspond to the number of digits in the PIN. In this instance, the pseudo PIN can be screen information that is indicative of where the user dragged from and dropped to on the touch screen of the mobile device. The user can drag and drop numbers that correspond to the user's PIN, but rather than communicating the user's PIN to the payment server, the mobile device communicates the locations on the touch screen which correspond to the drag-and-drop operations.

One observing the user enter the number would typically see only the drag-and-drop operations and not the numbers themselves. One electronically intercepting communications from the mobile device would only intercept the pseudo PIN, i.e., the information that is indicative of where the user dragged items from and dropped items to on the touch screen. Without knowing what numbers on the random keypad the locations correspond to, anyone intercepting the locations cannot determine the PIN. The payment server knows what numbers the drag-and-drop operations correspond to because the payment server defined the locations of the numbers of the random keypad and the slots.

The random keypad and/or the slots can be received from the payment server and shown on a merchant display at the point of sale. The display can be an electronic display, such as a television or a computer monitor. The display can be any other type of display. Thus, the additional information can be provided by the payment server.

Augmented reality can be used to enhance the touch screen display of the mobile device. In this manner, the user can be directed, at least partially, regarding where to tap the touch screen or where to perform drag-and-drop operations on the touch screen. For example, a merchant display can be imaged by a camera of the mobile device. Rather than merely presenting the merchant display on the touch screen of the mobile device, an application can be used to augment what is shown on the touch screen. For example, the random keypad and the empty slots can be enhanced on the mobile device screen via augmented reality. As a further example, the merchant display can contain an itemized list of products being purchased and the mobile device screen can overlay the list with the image of a shopping cart.

The numbers of the random keypad, outlines of the keys of the random keypad, a plurality of slots, a merchant token (representative of the merchant ID and the transaction), and the checkout receipt can be presented via augmented reality on the touch screen of the mobile device. The numbers, which are located within the outlines of the keys, can either be images of the numbers on the merchant display or can be graphics presented via augmented reality. Anything else, such as messages, coupons, advertisements, product information, and the like can be provided via augmented reality on the touch screen of the mobile device.

Everything shown on the touch screen can be augmented reality. Alternatively, a portion of what is shown on the touch screen can be augmented reality and another portion of what is shown on the touch screen can be an image taken by the camera of the mobile device. The image can be a portion of what is displayed by the merchant display.

Information regarding the user's mobile device can be sent from the mobile device to the payment server to facilitate reconstruction of the PIN. For example, an identification of the mobile device can be provided to the payment server. From the identification of the mobile device, the payment server can determine the size and aspect ratio of the touch screen so as to more readily be able to determine the positions and sizes of augmented reality graphics displayed thereon. Thus, the x-y positions of tap operations and drag-and-drop operations can more reliably be determined by the payment server.

Information regarding the augmented reality graphics can be communicated from the mobile device to the payment server. For example, information regarding the locations of the augmented reality graphics on the touch screen can be communicated from the mobile device to the payment server.

According to an embodiment, the information entered by the user, i.e., the pseudo PIN, and the additional information, i.e., the number sequence or number locations of the random keypad, can be communicated via two different networks to enhance the security provided the system. For example, the pseudo PIN can be communicated from the mobile device to the payment server via the cellular telephone network and the additional information can be communicated from the payment server to the merchant terminal via the Internet. The use of two different networks makes the illegitimate electronic interception of sufficient information to reconstruct the PIN much more difficult.

Devices other than a mobile device and a merchant display are contemplated. For example, the display can be any device that can show a random keypad or the like and the mobile device can be any device that can show an image captured from the display with augmented reality. For example, the mobile device can be a transparent touch screen.

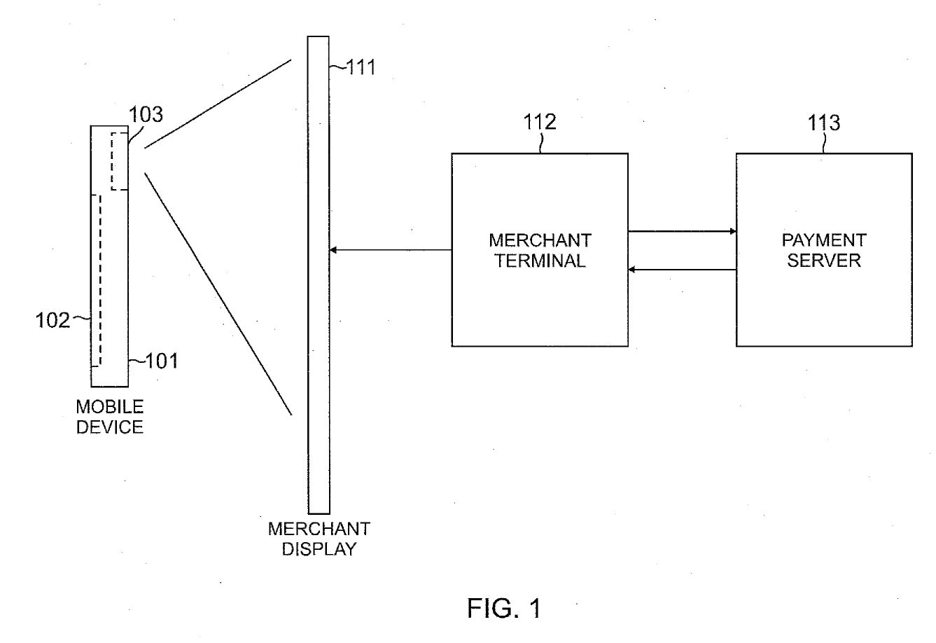

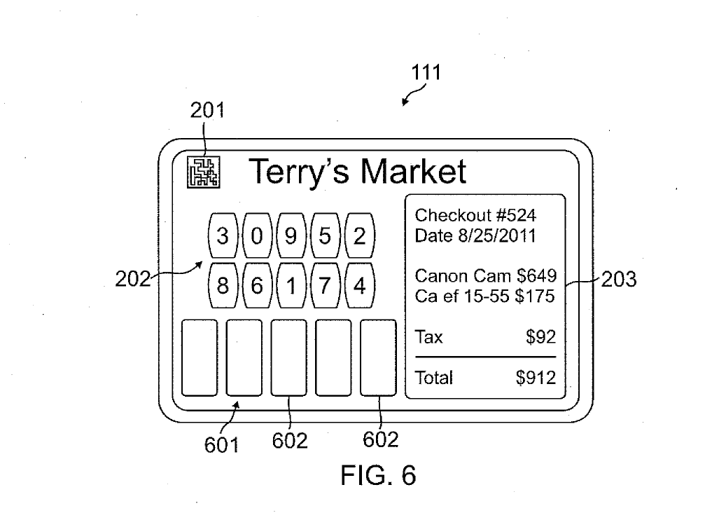

Referring now to FIGS. 1-5, an embodiment wherein numbers of a random keypad are tapped to enter the pseudo PIN is described. Another embodiment, wherein numbers of the random keypad are dragged and dropped is discussed with reference to FIGS. 6-9 below.

FIG. 1 is a block diagram showing the secure PIN verification system, in accordance with one or more embodiments. A mobile device 101 can have a touch screen 102 and a built-in camera 103. The mobile device 101 can be a laptop computer, a touch pad computer, a personal digital assistant (PDA), a cellular phone, or a smart phone, for example. The mobile device 101 can be any device that has a touch screen and is capable of imaging a scene and communicating information.

The camera 103 of the mobile device 101 can image a merchant display 111. The merchant display 111 can be in communication with a merchant terminal 112. Thus, the merchant terminal 112 can communicate the image shown on the merchant display 111 to the merchant display 111. The merchant display 111 and the merchant terminal 112 can be at the point of sale, such as a brick-and-mortar store. The merchant display 111 can be mounted on a wall, a cash register, a stand, or in any other manner.

The merchant terminal 112 can be in communication with a payment server 113 of a payment provider. Thus, the payment server 113 can communicate information regarding what is to be displayed on the merchant display 111 to the merchant terminal 112. The payment server 113 can be located remotely with respect to the point of sale. The merchant terminal 112 can have a processor, such as a central processing unit (CPU) for rendering point-of-sale checkout services, such as receipts and payment provider service objects. The store can have an inventory system in communication with the payment provider, such as via the payment server 113.

The mobile device 101 can define an interactive digital window that facilitates viewing of the merchant display 111 with augmented reality. The interactive digital window can also facilitate the entry of information from which the PIN can be reconstructed without entering the PIN. The user's windowed interactions with the mobile device 101 can be captured using augmented reality. These interactions can be isolated from the merchant terminal 112.

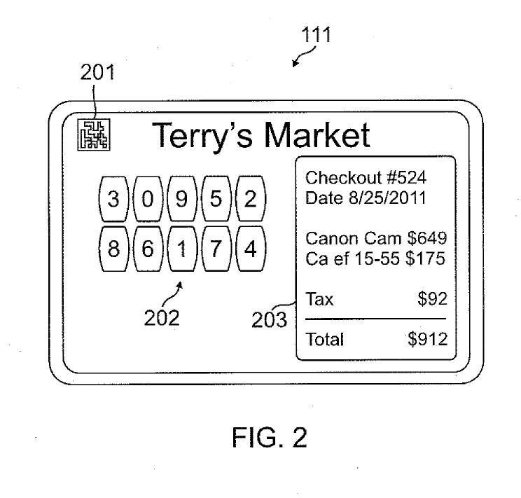

FIG. 2 shows the merchant display 111 for a particular checkout after a user has completed scanning the items being purchased and before payment has been made, in accordance with one or more embodiments. The merchant display 111 can be at the point of sale, e.g., at the check counter of a store. The information shown on the merchant display 111 can be obscured from view by people other than the user who is checking out. Thus, the information shown on the merchant display 111 can be contrived and known only to the payment provider 113, the merchant terminal 112, and the user.

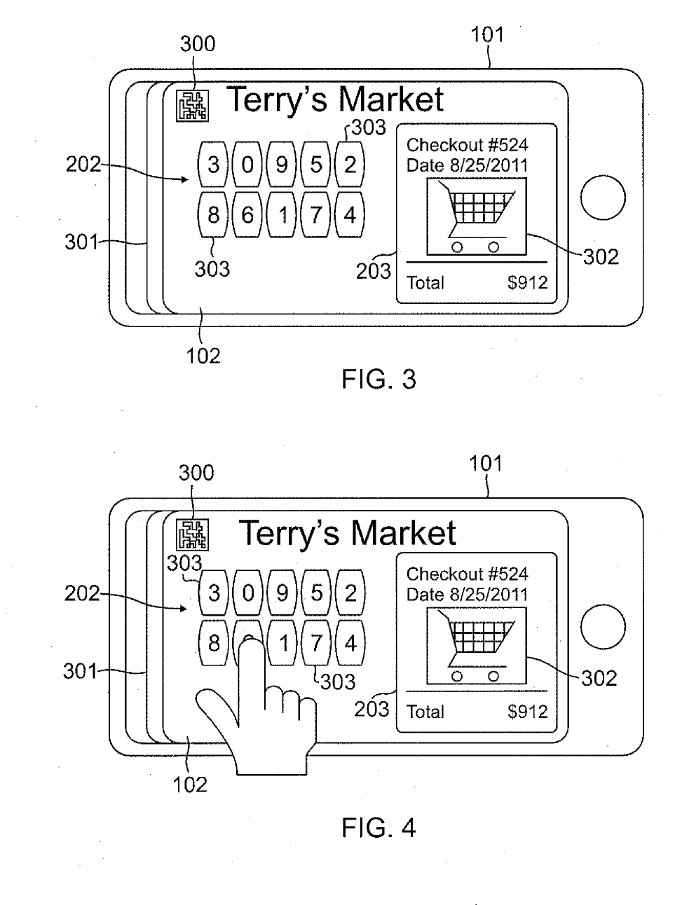

The merchant display 111 can show a first token 201, random keypad 202, and a checkout receipt 203. The checkout receipt 203 can include an itemized list of items purchased and the total due for the purchase. The merchant display 111 can show any other desired information. The sequence of numbers on the random keypad 202 can be determined by the payment server 113 and can be communicated to the merchant terminal 112 for display upon the merchant display 111, as discussed herein. The first token 201 can be generated from the merchant ID and the checkout receipt 203. The first token 201 can indicate which line, register, or checkout system is being used by the user. The line, register, or checkout system that is being used by the user can otherwise be shown on the merchant display 111. The first token 201 can be a bar code or the like. The first token 101 can be communicated to the payment server 113 and exchanged by the payment server 113 for a second token (300 of FIG. 3), as discussed herein.

FIG. 3 shows the touch screen 102 of the mobile device 101 when viewing an image 301 of the merchant display 111 of FIG. 2, in accordance with one or more embodiments. The image shown upon the touch screen 102 can be augmented with virtual reality graphics such that the image is different from the image shown on the merchant display 111. A graphic of a second token 300 and shopping cart 302 can overlay a portion of the touch screen 102. For example, the graphic of the second token 300 can overlay the image of the first token 201 and the graphic of the shopping cart 302 can overlay a portion of the image of the checkout receipt 203. Graphics of outlines 303 around the numbers of the random key pad 202 can be provided by augmented reality. The numbers, which are located within the outlines 303 of the keys, can either be images of the numbers on the merchant display 111 or can be graphics presented via augmented reality.

A software program or application (an app) can be used to provide the augmented reality graphics. The app can generate the graphics and can position and align the graphics on the touch screen 102. The app can be stored and executed on the mobile device 101. The augmented reality graphics can facilitate the generation of information by the user using the mobile device 103. For example, the graphic of the second token 300 can be dragged to the graphic of the shopping cart 302 to indicate acceptance of the transaction by the user. As a further example, the graphics of the outlines 303 of the numbers of the random keypad 202 can facilitate the tapping of numbers on the random keypad 202. Without the augmented reality graphics, the location of such items to be manipulated on the touch screen 102 would not be as well defined.

When the user launches the application, information regarding the user and the mobile device 101 can be communicated from the mobile device 101 to the payment server 113. The information (as well as any other information from the mobile device 101) can be communicated from the mobile device 101 to the payment server 113 via the cellular network or via a wide area network such as the Internet. The information can be communicated from the mobile device 101 to the payment server 113 via the merchant terminal 122. That is, the mobile device 101 can communicate the information to the merchant terminal 112 and the merchant terminal can communicate the information to the payment server 113. The mobile device 101 can communicate with the payment server 113 via the Internet, the cellular telephone network, or via any other method. The mobile device 101 can communicate with the payment server 113 via the merchant terminal 112 or without using the merchant terminal 112.

FIG. 4 shows the touch screen 102 of mobile device 101 of FIG. 3 when a user is entering the PIN, in accordance with one or more embodiments. The user can enter the PIN by tapping the keys or numbers of the random keypad 202. Since the locations of the numbers on the random keypad 202 are not standard, it is substantially more difficult for an observer to visually determine which numbers are being tapped. Rather than communicating the numbers to the payment server 113, the mobile device 101 communicates the positions tapped to the payment server 113. Electronically intercepting the positions tapped does not provide the PIN.

For example, if the user's PIN is 4157, then the user taps the number 4157 on the random keypad 202 of the touch screen 102. The user can tap an enter key, the shopping cart 302, or any other portion of the touch screen to indicated that entry is complete. The pseudo PIN is communicated to the payment server 113 once entry is complete. However, since the positions of the numbers are randomized or out of sequence on the random keypad 202, the user is actually tapping the positions for the number 0849, assuming that the positions of the numbers on a standard keypad are according to the sequence 1234567890. Thus, anyone visually observing the user tap the PIN using the random keypad 202 who is unable to see the numbers of the random keypad 202 would believe that the user is tapping 0849, which is not the PIN.

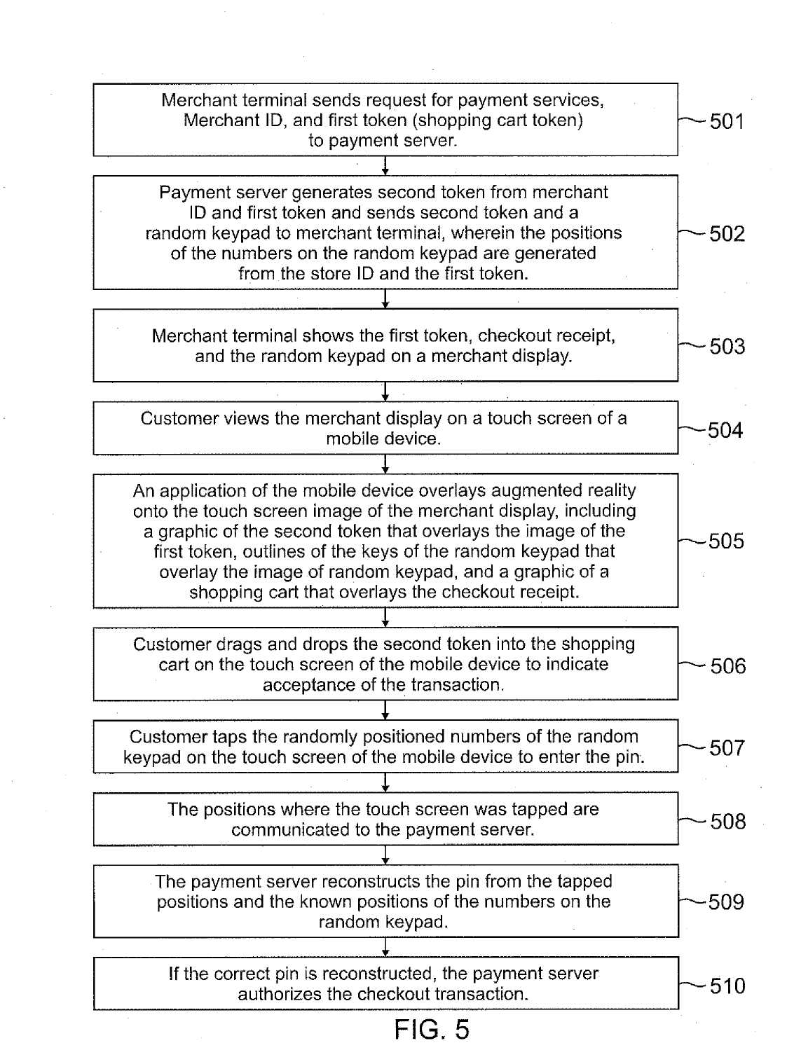

FIG. 5 is a flow chart showing the steps of secure PIN verification for mobile payment systems, in accordance with one or more embodiments. The merchant terminal 112 sends a request for payment services, a merchant ID, and a first token 201, e.g., a shopping cart token, to the payment server 113, as shown in step 501. The payment server 113 generates the second token 300 from merchant ID and first token 201 and sends second token 300 and the random keypad 202 to the merchant terminal 112, as shown in step 502. The second token 300 can be generated from the merchant ID and the first token by mathematically combining the merchant ID and the first token or by any other method. The second token 300 can include the random keypad 202.

The positions, e.g., the sequence, of the numbers on the random keypad 202 can be generated from the merchant ID and the first token 201. For example, the merchant ID and the first token 201 can be combined to form an initialization vector or seed that can be used by a random number generator or encryption algorithm to generate the sequence of numbers on the random keypad 202.

Thus, the positions of the numbers on the random keypad 202 can be generated using a random number generator or encryption algorithm. The positions of the numbers on the random keypad 202 can be generated using any method that results in random or pseudo random positions of the numbers on the random keypad 202.

The merchant terminal 112 can show the first token 201, the checkout receipt 203, and the random keypad 202 on the merchant display 111, as show in step 503. The user can view the merchant display 111 on the touch screen 102 using the camera 103 of the mobile device 101, as shown in step 504. An application of the mobile device 101 can overlay augmented reality onto the touch screen 102 image of the merchant display 111, as shown in step 505. The augmented reality can include a graphic of the second token 300 that overlays the image of the first token 201, the outlines 303 of the keys of the random keypad 202 that overlay the image of random keypad 202, and a graphic of a shopping cart 302 that overlays the checkout receipt 203.

The user can drag and drop the second token 300 into the shopping cart 302 on the touch screen 102 of the mobile device 101 to indicate acceptance of the transaction, as shown in step 506. The shopping cart 302 can change color (such as from red to green) to indicate that the second token 300 has been dropped therein. The user can tap the randomly positioned numbers of the random keypad 202 on the touch screen 102 of the mobile device 101 to enter the PIN, as shown in step 507.

The positions where the second token 300 was dragged from and dropped to and the positions where the touch screen 102 was tapped can be communicated to the payment server 113, as shown in 508. The payment server 113 can reconstruct the PIN from the tapped positions and the known positions of the numbers on the random keypad 202, as shown in step 509. That is, the payment server 113 can reconstruct the PIN by relating events from the windowed augmented realty of the touch screen 102 to the known positions of the numbers of the random keypad 202. If the correct PIN is reconstructed, the payment server 113 can authorize the checkout transaction, as shown in step 510.

Referring now to FIGS. 6-9, an embodiment wherein numbers of the random keypad 202 are dragged and dropped to enter the pseudo PIN is described. This embodiment is similar to the embodiment of FIGS. 1-5 described above, with the exception that the numbers are dragged and dropped instead of being tapped.

FIG. 6 shows the merchant display 111 for a particular checkout after a user has completed scanning the items purchased and before payment has been made, in accordance with one or more embodiments. The merchant display 111 of FIG. 6 can be similar to that of FIG. 2, except with input tracks or slots 601 added. The slots 601 can have outlines 602 formed thereabout. The slots 601 can facilitate drag-and-drop operations for the random keypad 202, as discussed herein.

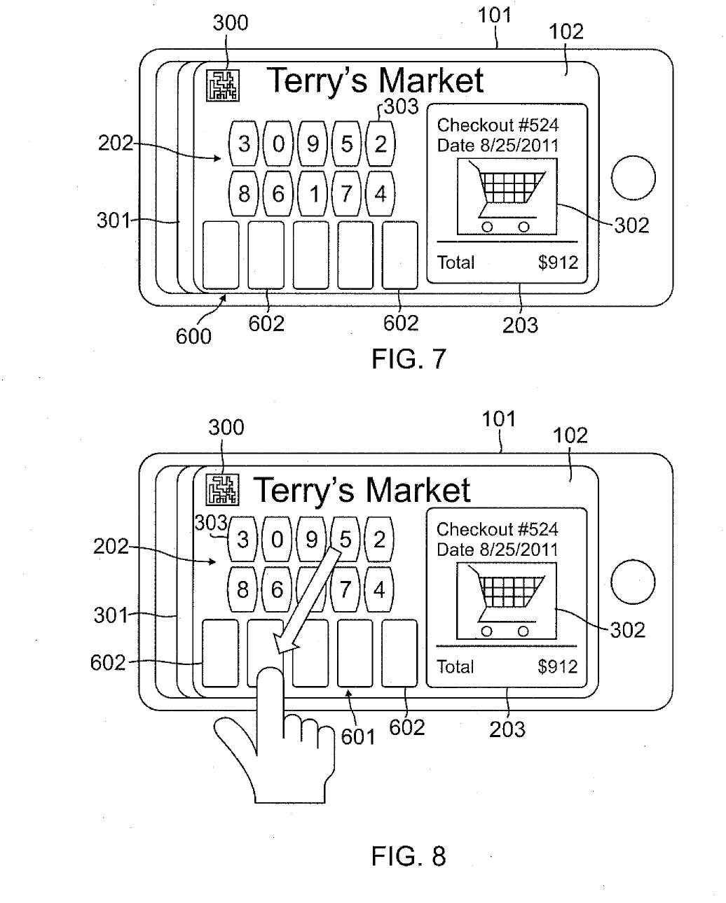

FIG. 7 shows the touch screen 102 of the mobile device 101 when viewing the merchant display 111 of FIG. 6, in accordance with one or more embodiments. The image 301 shown upon the touch screen 102 can be augmented with virtual reality graphics such that the image is different from the image shown on the merchant display 111. Graphics of a second token 300, the shopping cart 302 and the slots 601 can overlay a portion of the touch screen 102. Graphics of outlines 602 around each of the slots 601 can be provided by augmented reality. The numbers, which are located within the outlines 602 of the keys, can either be images of the numbers on the merchant display 111 or can be graphics presented via augmented reality.

FIG. 8 shows the touch screen 102 of mobile device 101 of FIG. 3 when a user is entering the PIN, in accordance with one or more embodiments. The user can enter the PIN by dragging and dropping the numbers of the random keypad 202. Since the locations of the numbers on the random keypad 202 are not standard, it is substantially more difficult for an observer to visually determine which numbers are being dragged and dropped. Rather than communicating the numbers to the payment server 113, the positions dragged from and dropped to are communicated by the mobile device 101 to the payment server 113. Electronically intercepting this drag-and-drop information does not provide the PIN.

For example, if the user's PIN is 4157, then the user drags and drops the number 4 into the first slot, drags and drops the number 1 into the second slot, drags and drops the number 5 into the third slot, and drags and drops the number 7 into the fourth slot. The user can tap an enter key, the shopping cart 302, or any other portion of the touch screen to indicated that entry is complete. The pseudo PIN is communicated to the payment server 113 once entry is complete. Thus, anyone visually observing the user drag and drop the PIN using the random keypad 202 who is unable to see the numbers of the random keypad 202 would not be able to determine the PIN.

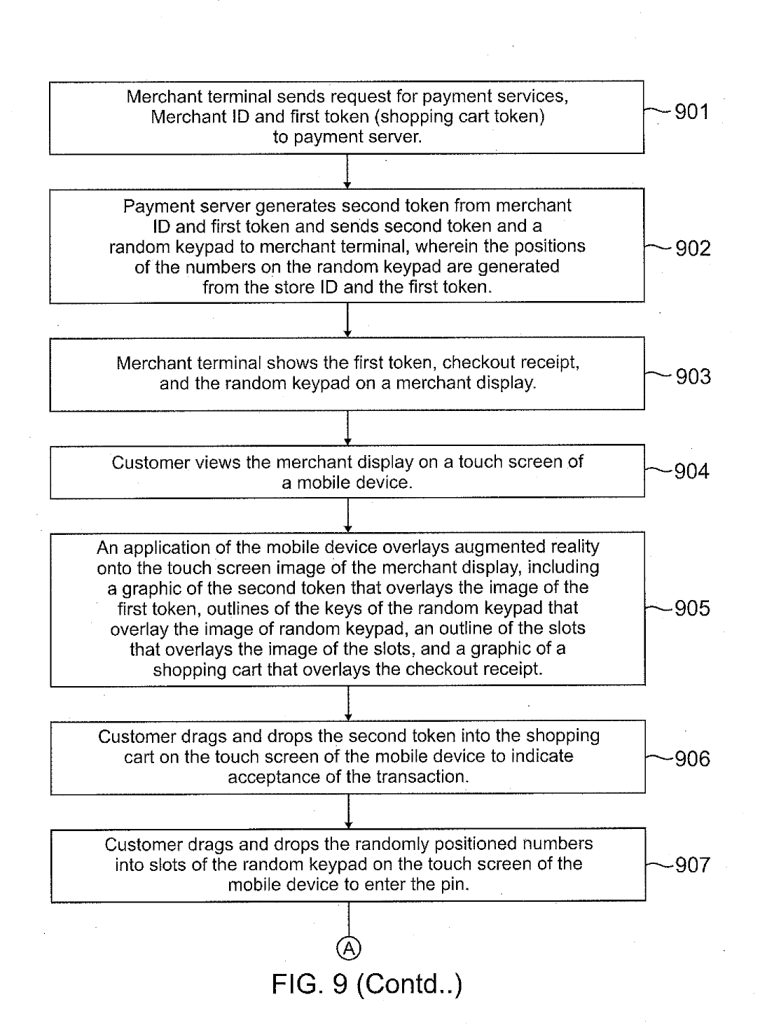

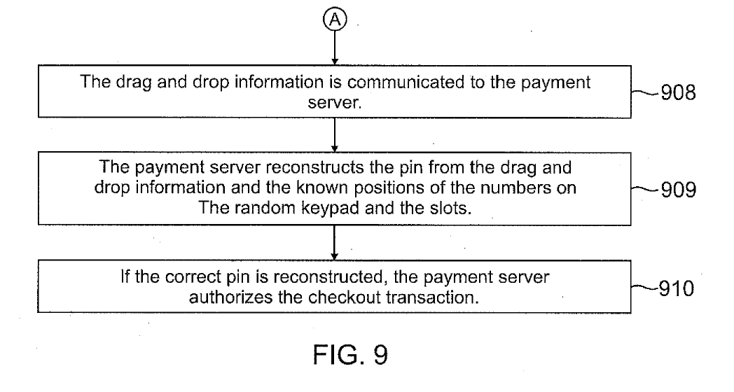

FIG. 9 is a flow chart showing the steps of secure PIN verification for mobile payment systems, in accordance with one or more embodiments. The merchant terminal 112 sends a request for payment services, a merchant ID, and a first token 201, e.g., a shopping cart token, to payment server 113, as shown in step 901. The payment server 113 generates the second token 300 from merchant ID and first token 201 and sends information representative of second token 300, the random keypad 202 and the slots 601 to the merchant terminal 112 as shown in step 902. The positions, e.g., the sequence; of the numbers on the random keypad 202 can be generated from the merchant ID and the first token 201. The second token 300 can include the random keypad 202, as discussed herein.

The positions of the numbers on the random keypad 202 can be generated using a random number generator, as discussed herein. The positions of the numbers on the random keypad 202 can be generated using any method that results in random or pseudo random positions of the numbers on the random keypad 202.

The merchant terminal 112 can show the first token 201, the checkout receipt 203, the random keypad 202 and the slots 601 on the merchant display 111, as show in step 903. The user can view the merchant display 111 on the touch screen 102 of the mobile device 101, as shown in step 904. An application of the mobile device 101 can overlay augmented reality onto the touch screen image of the merchant display 111 as shown in step 905. The augmented reality can include a graphic of the second token 300 that overlays the image of the first token 201, the outlines 303 of the keys of the random keypad 202 that overlay the image of random keypad 202, a graphic of a shopping cart 302 that overlays the checkout receipt 302, and graphics of the outlines 602 of the slots 601.

The user can drag and drop the second token 300 into the shopping cart 302 on the touch screen 102 of the mobile device 101 to indicate acceptance of the transaction, as shown in step 906. The shopping cart 302 can change color (such as from red to green) to indicate that the second token 300 has been dropped therein. The user can drag and drop the randomly positioned numbers of the random keypad 202 onto the slots 601 to enter the PIN, as shown in step 907.

The positions where the second token 300 was dragged from and dropped to and the positions where numbers of the random keypad 202 were dragged and dropped to can be communicated to the payment server 113, as shown in 908. The payment server 113 can reconstruct the PIN from the tapped positions and the known positions of the numbers on the random keypad 202, as shown in step 909. That is, the payment server 113 can reconstruct the PIN by relating events from the windowed augmented realty of the touch screen 102 to the known positions of the numbers of the random keypad 202. If the correct PIN is reconstructed, the payment server 113 can authorize the checkout transaction, as shown in step 910.

Thus, according to one or more embodiments, secure PIN verification is provided. Information regarding the PIN is forwarded from the point of sale to the payment server without the PIN being entered or captured on any device at the point of sale.

According to an embodiment, a user can view a random keypad 202 on the mobile device 101 and can enter the PIN on the physical merchant terminal 112. Entering the PIN on the merchant terminal 112 can be done when the mobile device 101 lacks a touch screen, for example. The numbers of the random keypad 202 can be generated by the payment server 113 and the numbers can be provided to the mobile device 101. Alternatively, the random keypad 202 can have the numbers thereof provided by an app of the mobile device 101 and the sequence of numbers on the random keypad 202 can be communicated from the mobile device 101 to the payment server 113. The positions of the numbers on random keypad 202 of the mobile device 101 can determine which numbers on the merchant terminal 112 are pressed. That is, the user can press the position on the keypad of the merchant terminal 112 where the number for the PIN is on the random keypad 202. For example, if the first number of the user's PIN is a “3” and the “3” is in the position on the mobile device's random keypad where a “7” would be on a standard (non-random) keypad, then the user presses the “7” key on the merchant terminal.

The terms “product” and “merchandise” can be used herein to include both products and services. Items purchased can include both products and services.

The merchant terminal can include any merchant equipment that communicates with the payment server or the merchant display. Thus, a merchant terminal can include a computer, a router, a modem, and other equipment.

The payment server can include a server that facilitates the authorization of a transaction, such as by the use of a PIN. A payment server can include ancillary devices, such as devices for at least partially defining what is shown on a merchant display and for reconstructing a PIN, as described herein.

The terms “payment server” and “payment provider” can be used synonymously herein. Thus, reference to a payment server can be reference to a payment provider and visa-versa. The terms “customer” and “user” can be used synonymously herein.

In implementation of the various embodiments, embodiments of the invention may comprise a personal computing device, such as a personal computer, a laptop computer, a touch pad computer, a PDA, a cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

Logic may be encoded in a computer readable and executable medium, which may refer to any medium that participates in providing instructions to the processor for execution. Such a medium may take many forms, including but not limited to, non-volatile media, volatile media, and transmission media. In one embodiment, the computer readable medium is non-transitory. In various implementations, non-volatile media includes optical or magnetic disks, such as disk drive component, volatile media includes dynamic memory, such as system memory component, and transmission media includes coaxial cables, copper wire, and fiber optics, including wires that comprise bus. In one example, transmission media may take the faun of acoustic or light waves, such as those generated during radio wave and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another.

Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Thus, methods and systems are disclosed for facilitating verification of a user's PIN without the PIN being compromised. Entry of the PIN cannot readily be observed visually. That is, a bystander cannot easily watch the user enter the PIN. Further, the PIN cannot be intercepted electronically. Augmented reality is used with a mobile device in a manner such that the PIN is not captured by any device at the point of sale.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

1. A system comprising:
a memory storing account information for a user, the account information including a personal identification number (PIN) for the user;
a processor operable to:
receive a communication from a merchant device of a merchant including an indication that the user is about to purchase an item from the merchant;
access an account of the user;
provide information representative of a random keypad to the merchant;
receive from a mobile device of the user touch screen information representative of which numbers on the random keypad were dragged and dropped by the user and to where the numbers were dragged and dropped;
make a reconstructed PIN from the random keypad and the touch screen information; and
determine if the reconstructed PIN is the PIN of the user and authorize the purchase of the item if the reconstructed PIN is the PIN of the user.

2. The system of claim 1, wherein the communication comprises a merchant ID and a first token that is representative of a shopping cart of the user.

3. The system of claim 2, wherein the random keypad is provided to the merchant via a second token.

4. The system of claim 1, wherein providing the random keypad to the merchant comprises providing a random number to the merchant and wherein the random keypad is derivable from the random number.

5. The system of claim 1, wherein providing the random keypad to the merchant comprises providing a non-repeating random sequence of ten digits to the merchant.

6. The system of claim 1, wherein the touch screen information is information representative of which numbers on the random keypad were tapped by the user.

7. (canceled)

8. The system of claim 1, wherein the system is a payment server.

9. A method comprising:
receiving, electronically by a processor of a payment server, a communication from a merchant device of a merchant including an indication that a user is about to purchase an item from the merchant;
accessing, by the processor, an account of the user;
providing, by the processor, information representative of a random keypad to the merchant;
receiving, by the processor from a mobile device of the user, touch screen information representative of which numbers on the random keypad were dragged and dropped by the user and to where the numbers were dragged and dropped;
making, by the processor, a reconstructed PIN from the random keypad and the touch screen information; and
determining if the reconstructed PIN is the PIN of the user and authorizing, by the processor, the purchase of the item if the reconstructed PIN is the PIN of the user.

10. The method of claim 9, wherein the communication comprises a merchant ID and a first token that is representative of a shopping cart of the user.

11. The method of claim 10, wherein the random keypad is provided to the merchant via a second token.

12. The method of claim 9, wherein providing the random keypad to the merchant comprises providing a random number to the merchant and wherein the random keypad is derivable from the random number.

13. The method of claim 9, wherein providing the random keypad to the merchant comprises providing a non-repeating random sequence of ten digits to the merchant.

14. The method of claim 9, wherein the touch screen information is information representative of which numbers on the random keypad were tapped by the user.

15. The method of claim 9, wherein the touch screen information is information respectative of which numbers on the random keypad were tapped by the user.

16. A non-transitory machine-readable medium comprising a plurality of machine-readable instructions which when executed by one or more processors of a server are adapted to cause the server to perform a method comprising:
receiving, electronically by a processor of a payment server, a communication from a merchant device of a merchant including an indication that a user is about to purchase an item from the merchant;
accessing, by the processor, an account of the user;
providing, by the processor, information representative of a random keypad to the merchant;
receiving, by the processor from a mobile device of the user, touch screen information representative of which numbers on the random keypad were dragged and dropped by the user and to where the numbers were dragged and dropped;
making, by the processor, a reconstructed PIN from the random keypad and the touch screen information; and
determining if the reconstructed PIN is the PIN of the user and authorizing, by the processor, the purchase of the item if the reconstructed PIN is the PIN of the user.

17. The non-transitory machine-readable medium of claim 16, wherein the communication comprises a merchant ID and a first token that is representative of a shopping cart of the user.

18. The non-transitory machine-readable medium of claim 17, wherein the random keypad is provided to the merchant via a second token.

19. The non-transitory machine-readable medium of claim 16, wherein providing the random keypad to the merchant comprises providing a random number to the merchant and wherein the random keypad is derivable from the random number.

20. The non-transitory machine-readable medium of claim 16, wherein providing the random keypad to the merchant comprises providing a non-repeating random sequence of ten digits to the merchant.

21. The non-transitory machine-readable medium of claim 16, wherein the touch screen information is information representative of which numbers on the random keypad were tapped by the user.

22. (canceled)
